(19) United States
(12) Patent Application Publication
(10) Pub. No.: US 2008/0088063 A1
(43) Pub. Date: Apr. 17, 2008

(54) Casting system and method for producing a veneer product

(75) Inventor: David W. Irvin, Zanesville, OH (US)

Correspondence Address: GALLAGHER & DAWSEY CO., L.P.A., P.O. BOX 785, COLUMBUS, OH, 43216, US

(73) Assignee: Heritage Stone LLC

(21) Appl. No.: 11/580,404

(22) Filed: Oct. 13, 2006

(51) Int. Cl. B28B 3/00

(52) U.S. Cl. 264/333; 425/406

(57) ABSTRACT

A casting system and method for producing a veneer product is provided. The casting system of the instant invention includes a feed system containing casting material and a receiver for receiving the casting material from the feed system. The receiver includes a pliable casting member having at least one casting compartment for receiving and forming the casting material, and may have a releasable rigid frame. The receiver and the feed system are operatively joined to guide the casting material into the at least one casting compartment. The method includes the steps of: first, conveying a receiver to a feed system; next, charging the feed system with a casting material; next, discharging the feed system, wherein the casting material is deposited into the at least one casting compartment; then, curing the casting material to form a veneer product; and finally, removing the veneer product from the at least one casting compartment.

### TECHNICAL FIELD

The instant invention relates to the field of casting, and more particularly to a casting system and method for producing a veneer product resembling natural stone.

### BACKGROUND OF THE INVENTION

It is well known that natural stone is a common material of construction used for building houses, commercial buildings, and other structures. Natural stone is a popular choice for building material due to its old-style and elegant appearance. However, the installation of natural stone is complicated and typically requires the expertise of a skilled craftsman, such as a stone mason, which can result in very high installation costs.

A solution to the high costs associated with using natural stone in building applications has been provided by the introduction of stone veneer products. Stone veneer products are typically thin panels having at least one surface that simulates the look and texture of natural stone. There are also cornerstone veneer products that are used for applications that involve corners or ninety degree angles. Generally, stone veneer products are manufactured by pouring a concrete mixture into a mold having at least one surface that replicates a stone-like texture, allowing the concrete to cure within the mold, and removing the cured veneer product from the mold.

The primary disadvantage of this process is that it is very labor intensive. Typically an operator is required to pour the concrete mixture into each mold and remove any excess concrete by hand. The labor intensive nature of the process inevitably leads to longer cycle times and higher manufacturing costs.

The art has needed an improved method for producing veneer products that is less labor intensive and more productive. The method and system of the present invention provides these desired qualities and significantly improves the state of the art of casting veneer products. With these capabilities taken into consideration, the instant invention addresses many of the shortcomings of the prior art and offers significant benefits heretofore unavailable.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The present invention is a casting system and method for producing a veneer product. In one embodiment of the method of casting a veneer product, the method begins by placing a receiver having a pliable casting member, which has at least one casting compartment, onto a conveyor. Second, the receiver is conveyed to a feed system, such that the receiver is disposed beneath the feed system; and then, charging the feed system with a casting material. Third, the feed system is discharged, wherein the feed system guides the casting material into the at least one casting compartment. Fourth, the casting material deposited into the at least one casting compartment is cured to form a veneer product. Finally, the veneer product is removed from the at least one casting compartment. In one embodiment, the method may include having the pliable casting member supported by a rigid frame at least during a portion of the method.

The method of the instant invention provides the benefit of reducing the amount of physical labor required to cast a veneer product. Traditional methods for casting veneer product have generally relied upon operators to pour casting materials into various molds and to remove the cured product by hand.

In one embodiment of the casting system of the present invention, the casting system includes a feed system containing a casting material and a receiver for receiving the casting material from the feed system. The feed system includes a feed cooperation system. The receiver has a pliable casting member having at least one casting compartment for receiving and forming the casting material, and a receiver cooperation system. The receiver cooperation system and the feed cooperation system are configured to mate together to operatively join the receiver and the feed system to guide the casting material into the at least one casting compartment.

In other embodiments, the rigid frame and the pliable casting member cooperate to form the receiver cooperation system, and the pliable casting member may be removable from the rigid frame. By separating the pliable casting member from the rigid frame, the pliable casting member may be flexed, bent, or contorted to aid in the removal of the veneer product from the pliable casting member. Furthermore, to aid in transport of the pliable casting member, the pliable casting member may further include at least one transport device.

In yet another embodiment, the casting system may have a receiver that includes a pliable casting member, and at least one angled product casting insert. Furthermore, the pliable casting member may include at least one angled compartment for receiving and forming the casting material, at least one transport device to aid in the transport of the pliable casting member, and a pliable casting member bottom surface formed with at least one flex enhancing feature to selectively reduce the rigidity of the pliable casting member when removing the veneer product from the pliable casting member.

In still another embodiment, the at least one angled product casting insert cooperates with the pliable casting member to form a receiver cooperation system. The receiver cooperation system mates with the feed cooperation system to operatively join the receiver and the feed system to guide the casting material into the at least one angled compartment. In addition to forming part of the receiver cooperation system, the angled product casting insert provides sufficient force to retain the casting material in the angled compartment and helps form the back contour of the veneer product. Again, different embodiments may benefit from the use of a rigid frame to support the receiver during some, or all, steps of the process.

The system of the instant invention enables a significant advance in the state of the art. The instant invention is, in addition, widely applicable to a large number of applications. Variations, modifications, alternatives, and alterations of the various preferred embodiments may be used alone or in combination with one another, as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 is a perspective view of an embodiment of the casting system of the present invention, not to scale;

FIG. 2 is an exploded perspective view of an embodiment of the receiver of the casting system of the present invention, not to scale;

FIG. 3 is an elevation view of an embodiment of the receiver of the casting system of the present invention, illustrating the stacking of receivers, not to scale;

FIG. 4 is an elevation view of an embodiment of the feed system and receiver of the present invention, not to scale;

FIG. 5 is an elevation view of an embodiment of the feed system and receiver of the present invention, not to scale;

FIG. 6 is a perspective view of an embodiment of the receiver of the casting system of the present invention, not to scale;

FIG. 7 is an elevation view of an embodiment of the receiver of the casting system of the present invention, not to scale;

FIG. 8 is an elevation view of an embodiment of the casting system of the present invention, not to scale; and

FIG. 9 is an exploded perspective view of an embodiment of the receiver of the casting system of the present invention, not to scale;

### DETAILED DESCRIPTION OF THE INVENTION

The casting system (50) and method for producing a veneer product (20) of the instant invention enables a significant advance in the state of the art. The preferred embodiments of the casting system (50) and method accomplish this by new and novel arrangements of elements and methods that are configured in unique and novel ways and which demonstrate previously unavailable but preferred and desirable capabilities.

The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

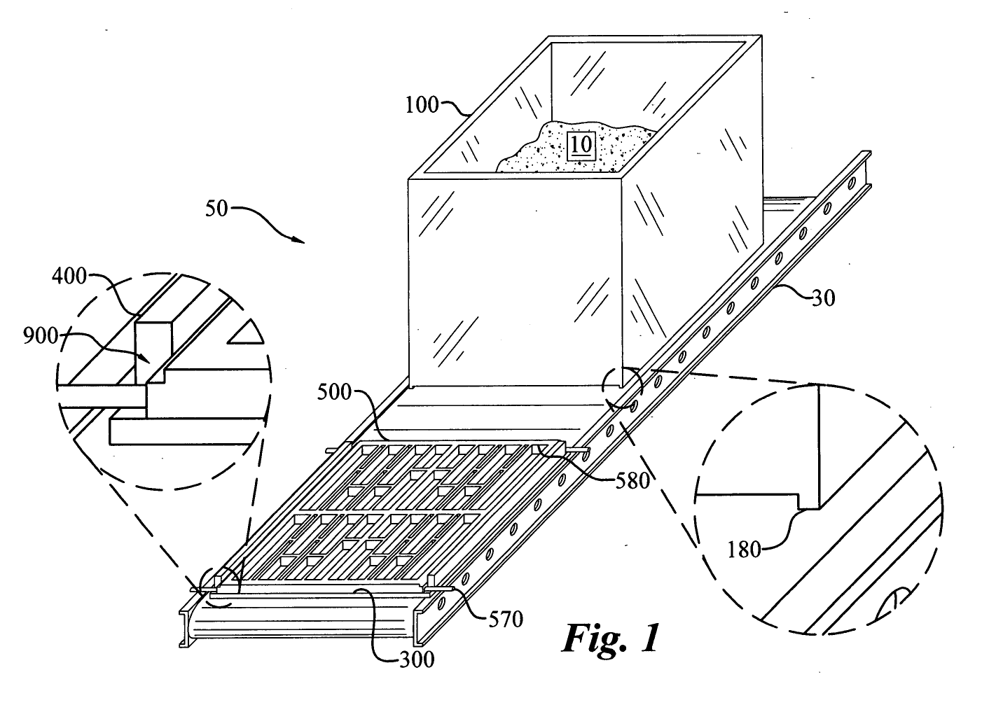

Referring now generally to FIGS. 1 through 9, the present invention is a casting system (50) and method for producing a veneer product (20). One embodiment of the method of casting a veneer product (20), shown generally in FIG. 1, includes the steps of: first, placing a receiver (300) having a pliable casting member (500) which has at least one casting compartment (580) onto a conveyor (30); next, conveying the receiver (300) to a feed system (100), such that the receiver (300) is disposed beneath the feed system (100); next, charging the feed system (100) with a casting material (10); next, discharging the feed system (100), wherein the feed system (100) guides the casting material (10) into the at least one casting compartment (580); then, curing the casting material (10) deposited into the at least one casting compartment (580) to form a veneer product (20); and finally, removing the veneer product (20) from the at least one casting compartment (580).

The method of the instant invention provides the benefit of reducing the amount of physical labor required to cast a veneer product (20). Traditional methods for casting veneer product (20) have generally relied upon operators to pour casting materials into various molds and to remove the cured product by hand. In one embodiment, the method may include having the pliable casting member (500) supported by a rigid frame (400) at least during the step of discharging the feed system (100).

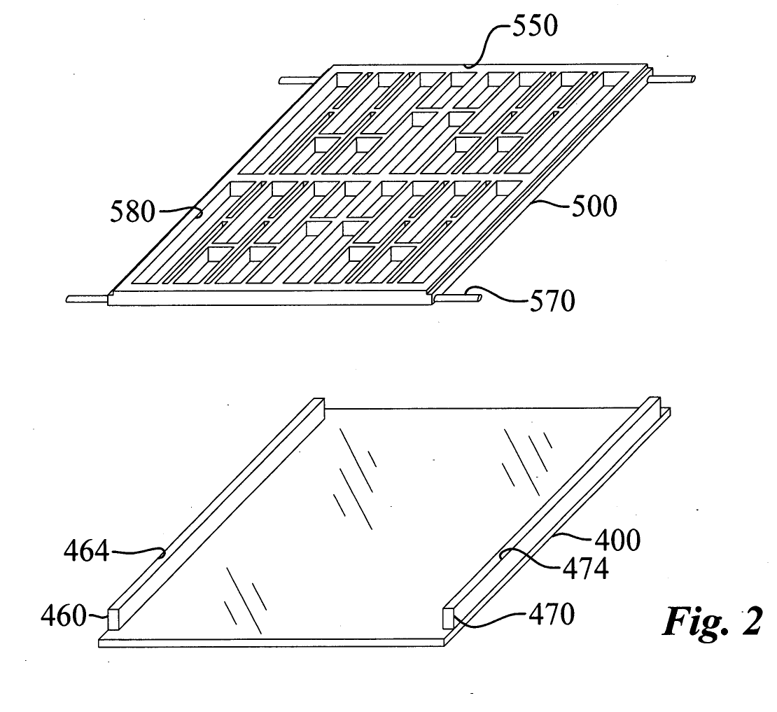

In another embodiment of the method, seen in FIG. 2, the method may further include the step of removing the pliable casting member (500) containing the cured veneer product (20) from the rigid frame (400). By removing the pliable casting member (500) from the rigid frame (400), the pliable casting member (500) may be flexed or otherwise contorted to aid in removing the veneer product (20) from the at least one casting compartment (580).

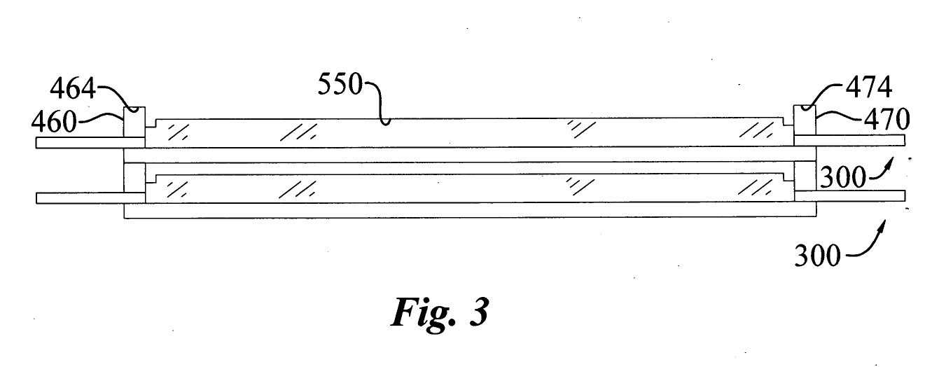

In yet another embodiment, seen in FIG. 3, the method may further include the step of stacking a plurality of receivers (300) upon one another after the casting material (10) is deposited into the receivers (300). Stacking the receivers (300) allows space to be conserved while the casting material (10) cures.

One embodiment of the casting system (50) of the instant invention is shown in FIG. 1. The casting system (50) includes a feed system (100) containing a casting material (10) and a receiver (300) for receiving the casting material (10) from the feed system (100). The feed system (100) includes a feed cooperation system (180). Still referring to FIG. 1, the receiver (300) has a pliable casting member (500), having at least one casting compartment (580) for receiving and forming the casting material (10), and a receiver cooperation system (900). The at least one casting compartment (580) is designed to form the casting material (10) such that the resulting veneer product (20) has the look and texture of natural stone.

Although FIG. 1 shows, for the sake of simplicity only, only one receiver (300) being conveyed to the feed system (100), it should be understood that a plurality of receivers (300) may be placed on the conveyor (30) and conveyed to the feed system (100). In one embodiment, a plurality of receivers (300) may be positioned on the conveyor (30) such that each receiver (300) abuts the receiver (300) in front of and behind each receiver (300). One having skill in the art will appreciate that the receiver (300) may be conveyed to the feed system (100) with or without the rigid frame (400). Thus, in another embodiment of the instant invention, only the pliable casting member (500) is conveyed to the feed system (100). In embodiments that do not employ a rigid frame (400), it may be desirable to have the conveyor (30) configured to cooperate with the shape of the pliable casting member (500) for support.

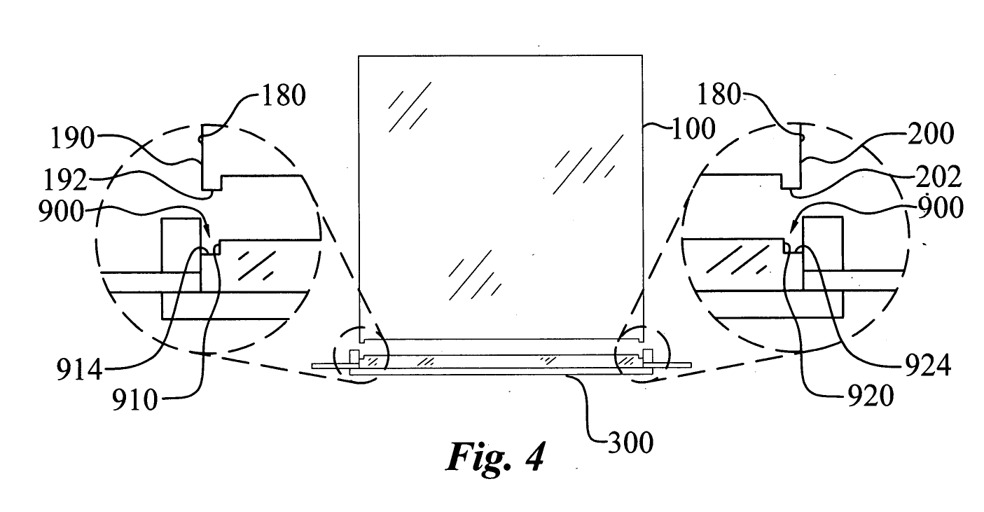

The receiver cooperation system (900) and the feed cooperation system (180) are configured to mate together to operatively join the receiver (300) and the feed system (100) to guide the casting material (10) into the at least one casting compartment (580), as seen in FIGS. 1 and 4. The joining of the receiver (300) and the feed system (100) creates a seal that prevents the casting material (10) from overflowing out of the receiver (300) when the at least one casting compartment (580) is filled with the casting material (10) as the receiver (300) passes through the feed system (100). The seal created by the joining of the receiver (300) and the feed system (100) acts as a barrier to the casting material (10) and forces the casting material (10) to be deposited within the at least one casting compartment (580). Furthermore, as the receiver (300) passes through the feed system (100), the feed system (100) acts as a screed to level off any excess casting material (10) that is not deposited within the at least one casting compartment (580). Thus, the seal created by the joining of the receiver (300) and the feed system (100) facilitates a process wherein a plurality of receivers (300) may be conveyed to the feed system (100) and filled with casting material (10) without the need for an operator to manually fill each receiver (300) and remove any excess casting material (10).

The receiver (300) may further comprise a releasable rigid frame (400) that cooperatively houses the pliable casting member (500). One with skill in the art will appreciate that the rigid frame (400) may be constructed of any rigid material including, but not limited to, lightweight metals, rigid plastics, and wood, or combinations thereof. Likewise, the pliable casting member (500) may be constructed of any pliable material including, but not limited to, pliable plastics, polyurethane, silicone, and various types of rubber materials. It should be noted that the pliable casting member (500) must also be durable. The pliable casting member (500) should be able to withstand repeated uses in which the pliable casting member (500) is flexed, stretched, or bent. To increase the life of the pliable casting member (500), the pliable material may include reinforcing fibers that increase the pliable casting member's (500) strength, yet still allows adequate flexibility. Furthermore, the casting material (10) may be any material suitable for exterior or interior building applications, such as a mixture containing portland cement, water and mineral aggregates, with or without other materials, such as coloring agents, liquid plastics, and other cementitious mixtures, just to name a few.

As seen in FIG. 1 and FIG. 2, the pliable casting member (500) may have a plurality of casting compartments (580). Each casting compartment (580) has at least one surface that simulates the look and texture of natural stone. The casting compartments (580) may be formed in a variety of sizes. By providing a variety of sizes, the veneer product (20) may be installed in a random pattern to better simulate the natural stone look. Furthermore, the particular arrangements of the casting compartments (580) within the pliable casting member (500) can have substantial benefits. One such benefit relates to the packaging of the veneer product (20). For example, a plurality of casting compartments (580) may be divided into four quadrants on the pliable casting member (500), which produce veneer product (20) covering a certain area. The packaging may then be designed such that one quadrant of veneer product (20) corresponds to one layer in the packaging. Thus, packaging may be designed to receive all four quadrants of veneer product (20), which would remove any guesswork on how to efficiently package a wide variety of shapes and sizes of veneer product (20).

In another embodiment of the casting system (50), seen in FIG. 4, the feed cooperation system (180) includes a sinistral feed cooperation member (190), formed with a sinistral feed male projection (192), and a dextral feed cooperation member (200), formed with a dextral feed male projection (202). For clarity in the drawing, FIG. 4 shows the feed system (100) separated from the receiver (300). However, it is to be understood that in operation the feed system (100) and the receiver (300) will be joined in intimate contact. In this embodiment, the receiver cooperation system (900) includes a sinistral receiver cooperation member (910), formed with a sinistral receiver female receiver (914), and a dextral receiver cooperation member (920), formed with a dextral receiver female receiver (924). The feed cooperation system (180) and the receiver cooperation system (900) are configured so that the sinistral feed male projection (192) is received by the sinistral receiver female receiver (914), and the dextral feed male projection (202) is received by the dextral receiver female receiver (924) to operatively join the receiver (300) to the feed system (100). The approximate size of the male projections (192, 202) is 2.54 cm (1 in) wide by 0.95 cm (⅜ in) long. Likewise, the female receivers (914, 924) are configured with approximately the same dimensions as that of the male projections (192, 202), such that the male projections (192, 202) tightly fit within the female receivers (914, 924).

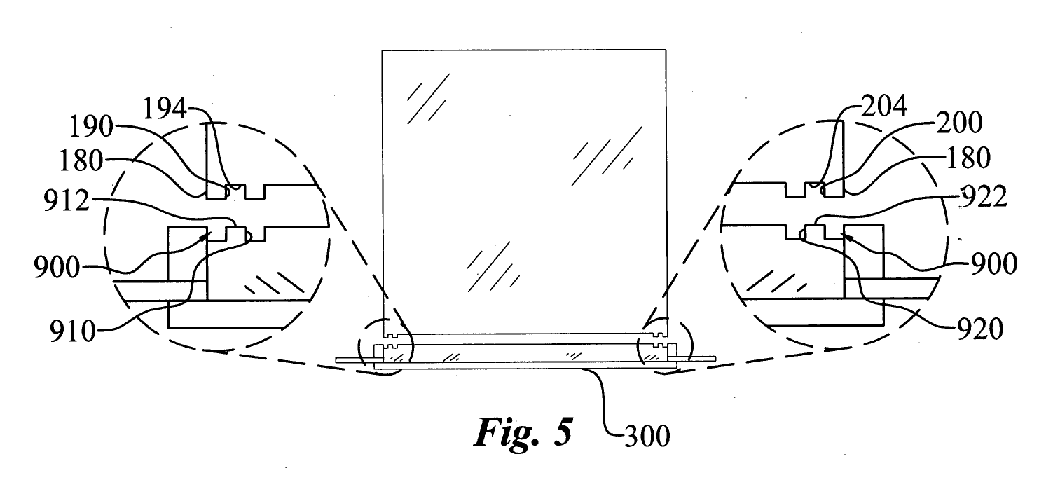

In still another embodiment of the casting system (50), seen in FIG. 5, the feed cooperation system (180) includes a sinistral feed cooperation member (190), formed with a sinistral feed female receiver (194), and a dextral feed cooperation member (200), formed with a dextral feed female receiver (204). As with FIG. 4, to make FIG. 5 clearer, the feed system (100) is shown as being separated from the receiver (300), when in actual operation they are joined. In this embodiment, the receiver cooperation system (900) includes a sinistral receiver cooperation member (910), formed with a sinistral receiver male projection (912), and a dextral receiver cooperation member (920), formed with a dextral receiver male projection (922). The feed cooperation system (180) and the receiver cooperation system (900) are configured so that the sinistral receiver male projection (912) is received by the sinistral feed female receiver (194) and the dextral receiver male projection (922) is received by the dextral feed female receiver (204) to operatively join the receiver (300) to the feed system (100). The approximate size of the male projections (912, 922) is 2.54 cm (1 in) wide by 0.95 cm (⅜ in) long. Likewise, the female receivers (194, 204) are configured with approximately the same dimensions as that of the male projections (912, 922), such that the male projections (912, 922) tightly fit within the female receivers (194, 204).

The embodiments of FIG. 4 and FIG. 5 represent only two configurations of how the receiver (300) may be mated with the feed system (100). One with skill in the art will appreciate that the receiver (300) may be interlocked with the feed system (100) utilizing various configurations and geometries of projections and receivers, such as triangular shaped projections and receivers, so long as the edges of the receiver (300) and the feed system (100) are reasonably sealed.

Referring now to FIG. 1, in another embodiment of the casting system (50), the rigid frame (400) and the pliable casting member (500) may cooperate to form the receiver cooperation system (900). As seen in FIG. 1, in this embodiment, the receiver cooperation system (900) is basically a channel or recess formed between the rigid frame (400) and the pliable casting member (500). Although FIG. 1 shows the receiver cooperation system (900) having a rectangular shape, one skilled in the art would recognize that the receiver cooperation system (900) may be formed in various other geometries.

In another embodiment of the casting system (50), as seen in FIG. 2, the pliable casting member (500) may be removable from the rigid frame (400). By separating the pliable casting member (500) from the rigid frame (400), the pliable casting member (500) may be flexed, bent, or contorted to aid in the removal of the veneer product (20) from the pliable casting member (500). Additionally, to aid in transporting the pliable casting member (500), the pliable casting member (500) may further include at least one transport device (570), also seen in FIG. 1. The at least one transport device (570) may be a bar or handle constructed of a suitably strong material, such as wood, carbon steel, or stainless steel, to name a few. The at least one transport device (570) may be configured to extend through the entire length of the pliable casting member (500). By extending through the entire length of the pliable casting member (500), the at least one transport device (570) provides sufficient support for mechanically lifting the pliable casting member (500) without excessive flexing or bending of the pliable casting member (500) that would cause the veneer product (20) to break.

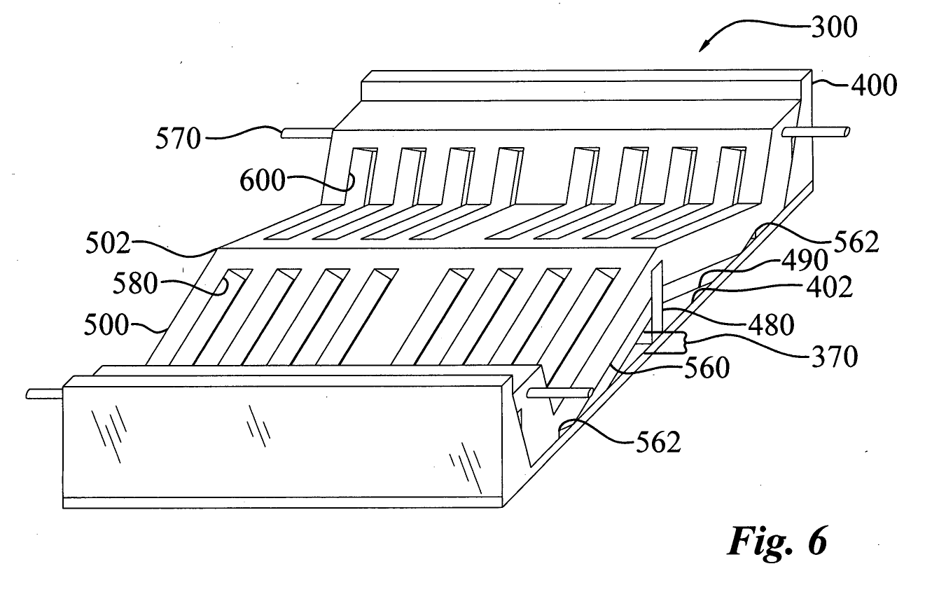

Furthermore, as seen in FIG. 6, the pliable casting member (500) has a pliable casting member bottom surface (560) that may be formed with at least one flex enhancing feature (562). The at least one flex enhancing feature (562) serves to selectively reduce the rigidity of the pliable casting member (500), which facilitates removal of the veneer product (20) from the pliable casting member (500). As shown in FIG. 6, the at least one flex enhancing feature (562) may be a v-shaped notch that extends the entire length of the pliable casting member bottom surface (560). The at least one flex enhancing feature (562) controls the location where the pliable casting member (500) is flexed by reducing the thickness of the pliable casting member (500). As seen in FIG. 6, the location of the at least one flex enhancing feature (562) closely corresponds to an angled portion of the pliable casting member (500). This helps the pliable casting member (500) peel away from the cured veneer product (20) during removal and also reduces the chance of the veneer product (20) breaking as it is being removed.

In another embodiment of the casting system (50), seen in FIG. 3, the receiver (300) may be configured such that a plurality of receivers (300) may be stacked upon one another to conserve storage space as the casting material (10) cures. In this particular embodiment, the rigid frame (400) further includes a first sidewall (460) having a first sidewall top surface (464) and a second sidewall (470) having a second sidewall top surface (474), and the pliable casting member (500) includes a pliable casting member top surface (550). As seen in FIG. 3, the pliable casting member top surface (550) is disposed at an elevation below that of the first and second sidewall top surfaces (464, 474). Since the first and second sidewall top surfaces (464, 474) are at an elevation above the pliable casting member top surface (550) a plurality of receivers (300) may be stacked upon one another without contacting the casting material (10) within the pliable casting member (500) of the receiver (300) below. Furthermore, this configuration creates a space between the stacked receivers (300) through which air may pass to further enhance heat transfer and curing of the casting material (10).

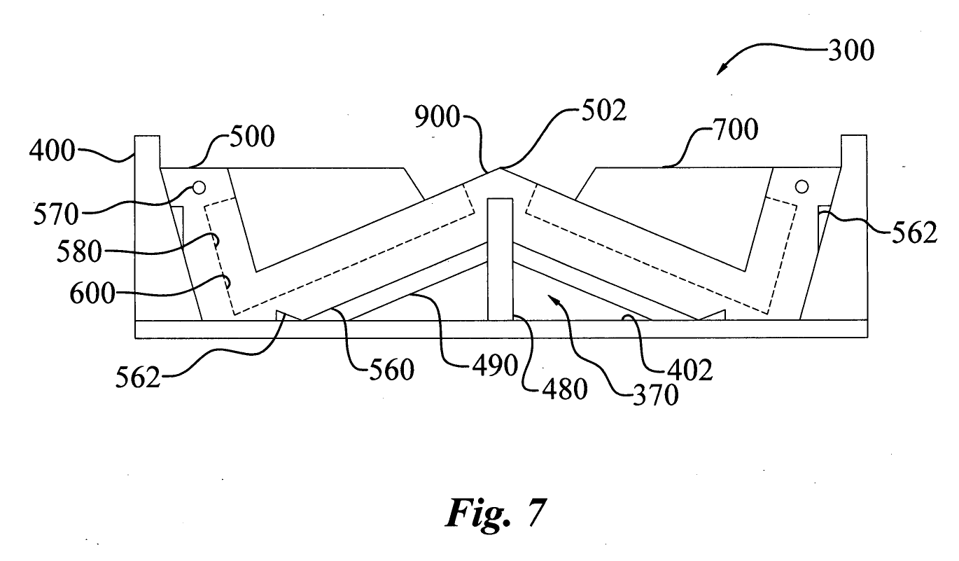

The casting system (50) may alternatively be configured to produce a veneer product (20) formed with an angle. In one embodiment of the casting system (50), seen in FIG. 7, the receiver (300) further includes an angled product casting insert (700) that cooperates with the pliable casting member (500) to form the receiver cooperation system (900). In this embodiment, the at least one casting compartment (580) is an angled compartment (600). One with skill in the art will appreciate that the angled compartment (600) may be configured in nearly any angle, not just the ninety degree angle used for corner veneer products. As seen in FIG. 7, the angled product casting insert (700) lies flush against the pliable casting member (500) and covers all but a small portion of the angled compartment (600), which provides an inlet for receiving the casting material (10). In addition, since the angled product casting insert (700) lies flush against the pliable casting member (500), the weight of the angled product casting insert (700) provides sufficient force to retain the casting material (10) in the angled compartment (600) and helps form the back contour of the veneer product (20). The angled product casting insert (700) may be constructed of the same materials as that of the rigid frame (400) disclosed above.

In another embodiment, seen in FIG. 7, the receiver (300) may further include at least two angled product casting inserts (700) that cooperate with the pliable casting member (500) to form the receiver cooperation system (900). In this embodiment, the pliable casting member (500) has at least two casting compartments (580), and the at least two casting compartments (580) are angled compartments (600). The at least two angled product casting inserts (700) lie flush against the pliable casting member (500) and cover all but a small portion of the angled compartments (600), which provides inlets for receiving the casting material (10). In addition, since the at least two angled product casting inserts (700) lie flush against the pliable casting member (500), the weight of the at least two angled product casting inserts (700) provides sufficient force to retain the casting material (10) in the angled compartments (600) and helps form the back contour of the veneer product (20).

Still referring to FIG. 7, the pliable casting member (500) may be formed with a vertex (502). In this embodiment, the at least two casting compartments (580) are disposed on opposing sides of the vertex (502). Additionally, the at least two angled product casting inserts (700) are disposed on opposing sides of the vertex (502). Thus, in this embodiment, the pliable casting member (500) is configured with two rows of casting compartments (580), as opposed to a single row which is common in the industry. As seen in FIG. 7, the at least two angled product casting inserts (700) lie flush against the pliable casting member (500) and cover all but a small portion of the at least two casting compartments (580), which provide inlets for receiving the casting material (10). This configuration provides the benefit of being able to simultaneously fill both rows of casting compartments (580) with the casting material (10), which results in twice as much veneer product (20) in the same cycle time.

In another embodiment, the rigid frame (400) may further include a pliable casting member bottom surface support (490), and the pliable casting member (500) may further include a pliable casting member bottom surface (560), as seen in FIG. 6. In this embodiment, the pliable casting member bottom surface (560) and the pliable casting member bottom surface support (490) are configured to form at least one void space (370) between the pliable casting member bottom surface support (490), and therefore also the pliable casting member bottom surface (560), and the rigid frame top surface (402). The at least one void space (370) provides at least one channel for air to pass through to promote heat transfer and curing of the casting material (10) within the pliable casting member (500).

In still another embodiment, the rigid frame top surface (402) may further include at least one auxiliary casting member support (480), seen in FIG. 6. The at least one auxiliary casting member support (480) cooperates with the pliable casting member bottom surface (560) to support a portion of the pliable casting member bottom surface support (490). As seen in FIG. 6, the at least one auxiliary casting member support (480) may be located approximately in the center of the rigid frame top surface (402), which coincides with the vertex (502) of the pliable casting member (500). Additionally, the at least one auxiliary casting member support (480) may function to support the pliable casting member bottom surface (560), which facilitates formation of the at least one void space (370). The at least one auxiliary casting member support (480) may be constructed of the same materials used to construct the rigid frame (400) previously disclosed.

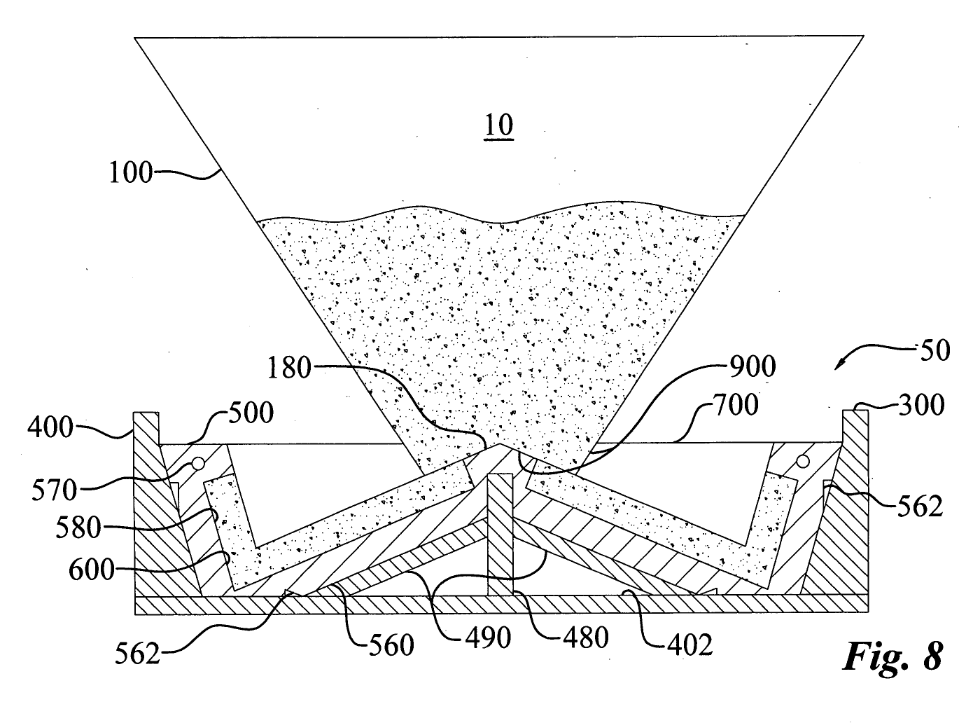

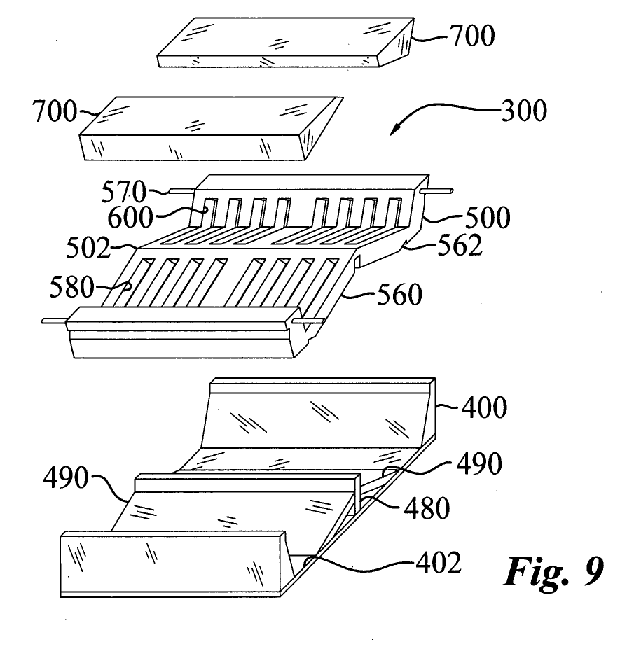

Another embodiment of the casting system (50) of the instant invention is shown in FIG. 8. The casting system (50) includes a feed system (100) containing a casting material (10) and a receiver (300) for receiving the casting material (10) from the feed system (100). The feed system (100) includes a feed cooperation system (180). Referring now to FIG. 9, the receiver (300) has a rigid frame (400), a pliable casting member (500) releasably mounted in the rigid frame (400), and at least one angled product casting insert (700).

As illustrated in FIG. 8, the feed system (100) may be a conical shaped hopper, shown in a simple form for illustration only. However, the feed system (100) may be configured as a system of two hoppers (not shown). The first hopper (not shown) is designed to contain a large volume of casting material (10) and to discharge a volumetric amount of casting material (10) sufficient to fill the receiver (300) into the second hopper, which is the feed system (100) shown in FIG. 8. The feed system (100) may also be equipped with vibrating means. By providing the feed system (100) with vibrating means, the casting material (10) flows more smoothly from the feed system (100) to the receiver (300). Additionally, in those embodiments where the feed system (100) is separate from the first hopper (not shown) storing a quantity of casting material (10), vibration of the feed system (100) to assist in the pouring and smoothing of the casting material (10) is less likely to affect materials stored in the first hopper, such as by way of example and not limitation only, the well known tendency of water to separate from concrete with vibration.

In the embodiments shown in FIGS. 8 and 9, the pliable casting member (500) has at least one angled compartment (600) for receiving and forming the casting material (10), at least one transport device (570) to aid in the removal of the pliable casting member (500) from the rigid frame (400), and a pliable casting member bottom surface (560) formed with at least one flex enhancing feature (562) to selectively reduce the rigidity of the pliable casting member (500) when removing the veneer product (20) from the pliable casting member (500).

Now referring to FIG. 8, the at least one angled product casting insert (700) cooperates with the pliable casting member (500) to form a receiver cooperation system (900). The receiver cooperation system (900) mates with the feed cooperation system (180) to operatively join the receiver (300) and the feed system (100) to guide the casting material (10) into the at least one angled compartment (600), also seen in FIG. 8.

As illustrated in FIG. 8, the at least one angled product casting insert (700) lies flush against the pliable casting member (500) and covers all but a small portion of the at least one angled compartment (600), which provides an inlet for receiving the casting material (10). In addition, since the at least one angled product casting insert (700) lies flush against the pliable casting member (500), the weight of the at least one angled product casting insert (700) provides sufficient force to retain the casting material (10) in the at least one angled compartment (600) and helps form the back contour of the veneer product (20).

The joining of the receiver (300) and the feed system (100) creates a seal that prevents the casting material (10) from overflowing out of the receiver (300) when the at least one casting compartment (580) is filled with the casting material (10) as the receiver (300) passes through the feed system (100). The seal created by the joining of the receiver (300) and the feed system (100) acts as a barrier to the casting material (10) and forces the casting material (10) to be deposited within the at least one angled compartment (600). Furthermore, as the receiver (300) passes through the feed system (100), the feed system (100) acts as a screed to level off any excess casting material (10) on the pliable casting member (500) that was not deposited within the at least one angled compartment (600). Thus, the seal created by the joining of the receiver (300) and the feed system (100) facilitates a process wherein a plurality of receivers (300) may be conveyed to the feed system (100) and filled with casting material (10) without the need for an operator to manually fill each receiver (300) and remove any excess casting material (10).

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A casting system (50) for producing a veneer product (20) from a casting material (10), the casting system (50) comprising:
(a) a feed system (100) containing the casting material (10), wherein the feed system (100) includes a feed cooperation system (180); and
(b) a receiver (300), for receiving the casting material (10) from the feed system (100), comprising a pliable casting member (500) having at least one casting compartment (580) for receiving and forming the casting material (10), and wherein the receiver (300) has a receiver cooperation system (900) that mates with the feed cooperation system (180) to operatively join the receiver (300) and the feed system (100) to guide the casting material (10) into the at least one casting compartment (580).

2. The casting system (50) of claim 1, wherein the feed cooperation system (180) includes a sinistral feed cooperation member (190), formed with a sinistral feed male projection (192), and a dextral feed cooperation member (200), formed with a dextral feed male projection (202), and wherein the receiver cooperation system (900) includes a sinistral receiver cooperation member (910), formed with a sinistral receiver female receiver (914), and a dextral receiver cooperation member (920), formed with a dextral receiver female receiver (924), wherein the sinistral feed male projection (192) is received by the sinistral receiver female receiver (914) and the dextral feed male projection (202) is received by the dextral receiver female receiver (924) such that the receiver (300) is operatively joined to the feed system (100).

3. The casting system (50) of claim 1, wherein the feed cooperation system (180) includes a sinistral feed cooperation member (190), formed with a sinistral feed female receiver (194), and a dextral feed cooperation member (200), formed with a dextral feed female receiver (204), and wherein the receiver cooperation system (900) includes a sinistral receiver cooperation member (910), formed with a sinistral receiver male projection (912), and a dextral receiver cooperation member (920), formed with a dextral receiver male projection (922), wherein the sinistral receiver male projection (912) is received by the sinistral feed female receiver (194) and the dextral receiver male projection (922) is received by the dextral feed female receiver (204) such that the receiver (300) is operatively joined to the feed system (100).

4. The casting system of claim 1, wherein the receiver (300) further comprises a releasable rigid frame (400) that cooperatively houses the pliable casting member (500).

5. The casting system (50) of claim 4, wherein the rigid frame (400) and the pliable casting member (500) cooperate to form the receiver cooperation system (900).

6. The casting system (50) of claim 1, wherein the receiver (300) further includes an angled product casting insert (700) that cooperates with the pliable casting member (500) to form the receiver cooperation system (900), wherein the at least one casting compartment (580) is an angled compartment (600) and the angled product casting insert (700) retains the casting material (10) in the angled compartment (600).

7. The casting system (50) of claim 4, wherein the pliable casting member (500) is removable from the rigid frame (400) so that the pliable casting member (500) may be flexed to aid in the removal of the veneer product (20) from the pliable casting member (500).

8. The casting system (50) of claim 1, wherein the pliable casting member (500) further includes at least one transport device (570) to aid in the transport of the pliable casting member (500).

9. The casting system (50) of claim 7, wherein the pliable casting member (500) has a pliable casting member bottom surface (560) formed with at least one flex enhancing feature (562) to selectively reduce the rigidity of the pliable casting member (500) and facilitate removal of the veneer product (20) from the pliable casting member (500).

10. The casting system (50) of claim 4, wherein the rigid frame (400) further includes a first sidewall (460) having a first sidewall top surface (464) and a second sidewall (470) having a second sidewall top surface (474), and the pliable casting member (500) has a pliable casting member top surface (550), wherein the pliable casting member top surface (550) is disposed at an elevation below that of the first sidewall top surface (464) and the second sidewall top surface (474) so that a plurality of receivers (300) may be stacked upon one another to conserve space as the casting material (10) cures.

11. The casting system (50) of claim 1, wherein the receiver (300) further includes at least two angled product casting inserts (700) that cooperate with the pliable casting member (500) to form the receiver cooperation system (900), and wherein the pliable casting member (500) has at least two casting compartments (580), and the at least two casting compartments (580) are angled compartments (600), wherein the at least two angled product casting inserts (700) cooperate with the angled compartments (600) to retain the casting material (10) in the angled compartments (600).

12. The casting system (50) of claim 11, wherein the pliable casting member (500) is formed with a vertex (502), and each of the at least two casting compartments (580) and each of the at least two angled product casting inserts (700) are disposed on opposing sides of the vertex (502).

13. The casting system (50) of claim 4, wherein the rigid frame (400) further includes a pliable casting member bottom surface support (490), and the pliable casting member (500) further includes a pliable casting member bottom surface (560), wherein the pliable casting member bottom surface (560) and the pliable casting member bottom surface support (490) cooperate to support the pliable casting member bottom surface (560) and are configured to form at least one void space (370) between the pliable casting member bottom surface support (490) and the rigid frame top surface (402).

14. The casting system (50) of claim 13, wherein the rigid frame (400) further includes at least one auxiliary casting member support (480), and the at least one auxiliary casting member support (480) supports a portion of the pliable casting member bottom surface support (490).

15. A method of casting a veneer product (20), the method comprising:
(a) placing a receiver (300) onto a conveyor (30), the receiver (300) having a pliable casting member (500) having at least one casting compartment (580), and a receiver cooperation system (900);
(b) conveying the receiver (300) to a feed system (100), the feed system (100) having a feed cooperation system (180), wherein the receiver cooperation system (900) mates with the feed cooperation system (180) to operatively join the receiver (300) and the feed system (100) such that the receiver (300) is disposed beneath the feed system (100);
(c) charging the feed system (100) with a casting material (10);
(d) discharging the feed system (100), wherein the feed system (100) guides the casting material (10) into the at least one casting compartment (580);
(e) curing the casting material (10) deposited into the at least one casting compartment (580) to form a veneer product (20); and
(f) removing the veneer product (20) from the at least one casting compartment (580).

16. The method of claim 15, wherein the feed cooperation system (180) includes a sinistral feed cooperation member (190), formed with a sinistral feed male projection (192), and a dextral feed cooperation member (200), formed with a dextral feed male projection (202), and wherein the receiver cooperation system (900) includes a sinistral receiver cooperation member (910), formed with a sinistral receiver female receiver (914), and a dextral receiver cooperation member (920), formed with a dextral receiver female receiver (924), such that when the receiver (300) is operatively joined to the feed system (100) the sinistral feed male projection (192) is received by the sinistral receiver female receiver (914) and the dextral feed male projection (202) is received by the dextral receiver female receiver (924).

17. The method of claim 15, wherein the feed cooperation system (180) includes a sinistral feed cooperation member (190), formed with a sinistral feed female receiver (194), and a dextral feed cooperation member (200), formed with a dextral feed female receiver (204), and wherein the receiver cooperation system (900) includes a sinistral receiver cooperation member (910), formed with a sinistral receiver male projection (912), and a dextral receiver cooperation member (920), formed with a dextral receiver male projection (922), such that when the receiver (300) is operatively joined to the feed system (100) the sinistral receiver male projection (912) is received by the sinistral feed female receiver (194) and the dextral receiver male projection (922) is received by the dextral feed female receiver (204).

18. The method of claim 15, wherein the receiver (300) further includes an angled product casting insert (700) that cooperates with the pliable casting member (500) to form the receiver cooperation system (900), wherein the at least one casting compartment (580) is an angled compartment (600), such that the casting material (10) is guided into the angled compartment (600) and the angled product casting insert (700) retains the casting material (10) in the angled compartment (600).

19. The method of claim 15, wherein the pliable casting member (500) is supported by a rigid frame (400) at least during the step of discharging the feed system (100).

20. The method of claim 19, further including the step of removing the pliable casting member (500) containing the cured veneer product (20) from the rigid frame (400) and flexing the pliable casting member (500) to remove the veneer product (20) from the at least one casting compartment (580).

21. The method of claim 15, wherein the pliable casting member (500) has a pliable casting member bottom surface (560) formed with at least one flex enhancing feature (562) to selectively reduce the rigidity of the pliable casting member (500) and facilitate removal of the cured veneer product (20) from the at least one casting compartment (580).

22. The method of claim 19, further including the step of stacking a plurality of receivers (300) upon one another to conserve space as the casting material (10) cures, wherein the rigid frame (400) includes a rigid frame first sidewall (460) having a rigid frame first sidewall top surface (464) and a rigid frame second sidewall (470) having a rigid frame second sidewall top surface (474), and the pliable casting member (500) has a pliable casting member top surface (550), wherein the pliable casting member top surface (550) is disposed at an elevation below that of the rigid frame first sidewall top surface (464) and the rigid frame second sidewall top surface (474).

23. The method of claim 15, wherein the receiver (300) further includes at least two angled product casting inserts (700) that cooperate with the pliable casting member (500) to form the receiver cooperation system (900), and wherein the pliable casting member (500) has at least two casting compartments (580), and the at least two casting compartments (580) are angled compartments (600), wherein the at least two angled product casting inserts (700) cooperate with the angled compartments (600) to retain the casting material (10) in the angled compartments (600).

24. A casting system (50) for producing a veneer product (20) from a casting material (10), the casting system (50) comprising:
(a) a feed system (100) containing the casting material (10), wherein the feed system (100) includes a feed cooperation system (180); and
(b) a receiver (300), for receiving the casting material (10) from the feed system (100), having:
(i) a rigid frame (400);
(ii) a pliable casting member (500) releasably mounted in the rigid frame (400), the pliable casting member (500) having:
(A) at least one angled compartment (600) for receiving and forming the casting material (10);
(B) at least one transport device (570) to aid in the removal of the pliable casting member (500) from the rigid frame (400); and
(C) a pliable casting member bottom surface (560) formed with at least one flex enhancing feature (562) to selectively reduce the rigidity of the pliable casting member (500) when removing the veneer product (20) from the pliable casting member (500), and;
(iii) at least one angled product casting insert (700) that cooperates with the pliable casting member (500) to form a receiver cooperation system (900) that mates with the feed cooperation system (180) to operatively join the receiver (300) and the feed system (100) to guide the casting material (10) into the at least one angled compartment (600), wherein the at least one angled product casting insert (700) retains the casting material (10) in the at least one angled compartment (600).
